(19) United States
(12) Patent Application Publication
(10) Pub. No.: US 2024/0185312 A1
(43) Pub. Date: Jun. 6, 2024

(54) SYSTEM AND METHOD FOR SELF-BILLING ONE OR MORE PRODUCTS IN A COMPUTING ENVIRONMENT

(71) Applicant: ParallelDots, Inc., Lewes, DE (US)

(72) Inventors: Muktabh Mayank Srivastava, Gorakhpur (IN); Angam Parashar, Gwalior (IN); Ankit Narayan Singh, Rishikesh (IN)

(21) Appl. No.: 18/060,982

(22) Filed: Dec. 2, 2022

(51) Int. Cl. G06Q 30/04; G06Q 10/087; G06Q 30/0601; G06V 10/75; G06V 10/82; G06V 20/50

(52) U.S. Cl. CPC G06Q 30/04; G06Q 10/087; G06Q 30/0625; G06V 10/75; G06V 10/82; G06V 20/50

(57) ABSTRACT

A system and method for self-billing one or more products on a self-checkout application is disclosed. The computing system comprises one or more hardware processors and a memory coupled to the one or more hardware processors. The memory comprises a plurality of modules in the form of programmable instructions executable by the one or more hardware processors. The plurality of modules comprises an image receiver module, a visual signature generation module, a product determination module, a product parameter extraction module, and the like. The plurality of modules further comprises a record generation module configured to generate one or more electronic records s based on received one or more images and one or more product parameters. The plurality of modules further comprises an output module configured to output the generated one or more electronic records on a user interface of one or more electronic devices associated with a user.

### FIELD OF INVENTION

Embodiments of the present disclosure relates to autonomous store systems and more particularly to a system and method for self-billing one or more products in a computing environment.

### BACKGROUND

A lot of consumer's time is spent in waiting at a long billing queue at stores after shopping. Self-checkout in the stores after the shopping enables consumers to focus on shopping rather than waiting at the long billing queues. Existing invention comprises ways to enable the self-checkout in the store. For example, there are store camera enabled self-checkout solutions to track consumer's behaviour in the store and bill products automatically. However, these store cameras enabled self-checkout solutions require constant surveillance and video processing which may not be cost effective, and this may not be acceptable to some consumers. Further, other existing inventions enable the self-checkout by scanning a barcode on a consumer's camera present on a consumer's electronics device. However, they are not user friendly. Further, self-checkout kiosks are available as one of the solutions for the self-checkout in the stores, however they solve problems of replacing cashiers and does not solve the problem of waiting at the long billing queues.

Hence there is a need for an improved system and method for self-billing one or more products in a computing environment to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

Embodiments of the present disclosure comprises a computing system capable of self-billing one or more products. The computing system comprises one or more hardware processors (also referred as processor(s)) and a memory coupled to the one or more hardware processors. The memory comprises a plurality of modules in the form of programmable instructions executable by the one or more hardware processors.

The plurality of modules comprises an image receiver module configured to receive at least one of or more images or one or more videos from a user via the one or more electronic devices associated with the user.

The plurality of modules further comprises a visual signature generation module configured to generate one or more visual signatures based on the received one or more images or one or more videos using visual signature based convolutional neural network model. The generated one or more visual signatures are stored in the form of a queryable data structure in a storage database.

The plurality of modules further comprises a product determination module configured to determine the one or more products corresponding to the generated one or more visual signatures.

The plurality of modules further comprises a product parameter extraction module configured to obtain one or more product parameters from the determined one or more products. The one or more product parameters comprises name of the one or more products, price details of the one or more products, offers presented for the one or more products, manufactured date and expiry date of the one or more products, coupons applicable for the one or more products.

The plurality of modules further comprises a record generation module configured to generate one or more electronic records based on the received one or more images and the one or more product parameters.

The plurality of modules further comprises an output module configured to output the generated one or more electronic records on a user interface of the one or more electronic devices associated with the user.

Embodiments of another disclosure comprises a method for self-billing one or more products. The method comprises receiving at least one of or more images or one or more videos from the user via the one or more electronic devices associated with the user.

The method further comprises generating the one or more visual signatures based on the received one or more images or one or more videos using the visual signature based convolutional neural network model. The generated one or more visual signatures are stored in the form of the queryable data structure in the storage database.

The method further comprises determining the one or more products corresponding to the generated one or more visual signatures.

The method further comprises obtaining the one or more product parameters from the determined one or more products. The one or more product parameters comprises the name of the one or more products, the price details of the one or more products, the offers presented for the one or more products, the manufactured date, and the expiry date of the one or more products, and the coupons applicable for the one or more products.

The method further comprises generating the one or more electronic records based on the received one or more images and the one or more product parameters.

The method further comprises outputting the generated one or more electronic records on the user interface of the one or more electronic devices associated with the user.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram depicting a computing environment capable of self-billing one or more products, in accordance with an embodiment of the present disclosure;

FIG. 2 is a block diagram depicting a computing system, such as those shown in FIG. 1, capable of self-billing one or more products, in accordance with an embodiment of the present disclosure;

FIG. 3 is a block diagram depicting a process of creation of one or more visual signatures, in accordance with an embodiment of the present disclosure;

FIG. 4 is a block diagram depicting a process of updating visual signature in a database, in accordance with an embodiment of the present disclosure;

FIG. 5 is an exemplary process flowchart depicting a process of performing device operations on a self-checkout application, in accordance with an embodiment of the present disclosure; and

FIG. 6 is an exemplary process flowchart depicting a method for self-billing one or more products, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or modules or elements or structures or components preceded by “comprises . . . a” does not, without more constraints, preclude the existence of other devices, modules, elements, structures, components, additional devices, additional modules, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Throughout this document, the terms browser and browser application may be used interchangeably to mean the same thing. In some aspects, the terms web application and web app may be used interchangeably to refer to an application, including metadata, that is installed in a browser application. In some aspects, the terms web application and web app may be used interchangeably to refer to a website and/or application to which access is provided over a network (e.g., the Internet) under a specific profile (e.g., a website that provides email service to a user under a specific profile). The terms extension application, web extension, web extension application, extension app and extension may be used interchangeably to refer to a bundle of files that are installed in the browser application to add functionality to the browser application. In some aspects, the term application, when used by itself without modifiers, may be used to refer to, but is not limited to, a web application and/or an extension application that is installed or is to be installed in the browser application.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module may comprise dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

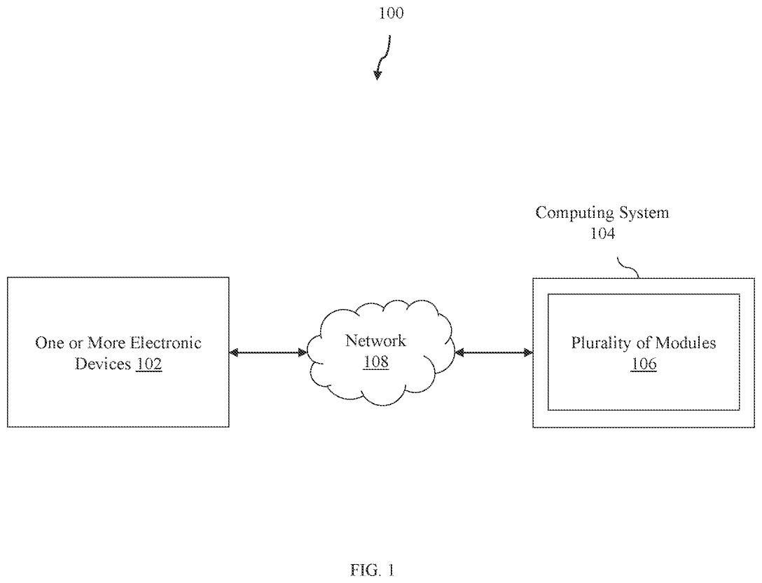

Referring now to the drawings, and more particularly to FIGS. 1 through 6, where similar reference characters denote corresponding features consistently throughout the figures, there are shown preferred embodiments and these embodiments are described in the context of the following exemplary system and/or method.

Embodiments of the present disclosure comprises a system and method for self-billing one or more products in a computing environment. A proprietary neural network is trained to create one or more visual signatures using a visual signature based convolutional neural network model. While enabling a self-checkout application present on one more electronic devices for a store, one or more images of the one or more products of an image registry comprising a data associated with an inventory of a store is collected and one or visual signatures are generated for each of the one or more images and these one or more visual signatures are stored in a prestored visual signature database. If all samples of the one of one or more products look similar, then one of one or more images of the sample is sufficient to create the one or more visual signatures of those samples. Further, during shopping in the store, a consumer downloads the self-checkout application and clicks one or more images of the one or more products present in a consumer's shopping cart on the self-checkout application. The self-checkout application may be present on one or more electronic devices associated with the consumer. The one or more visual signatures are generated for the one or more products present in the consumer's shopping cart. Further, the generated one or more visual signatures is compared with prestored one or more visual signatures in the prestored visual signature database to understand which one or more products is present in the consumer's shopping cart. This aforementioned comparison is performed using mathematical formula of Euclidean distance or Cosine Distance depending on the image registry. In some cases, if more than one product has a similar one or more visual signatures, then a prompt notification appears on the self-checkout application to clarify which one or more products to be matched. Examples of the store may be grocery store, medical store, retail store and the like. Throughout the document, a user may also be referred as the consumer.

FIG. 1 is a block diagram depicting a computing environment 100 capable of self-billing one or more products, in accordance with an embodiment of the present disclosure. According to the FIG. 1, the computing environment 100 includes a computing system 104. In an embodiment of the present disclosure, the computing system 104 is connected to one or more electronic devices 102 via a network 108. The network 108 may be a wireless or a wired network. The one or more electronic devices 102 may be a laptop computer, a desktop computer, a tablet computer, a smartphone, and the like. In another embodiment of the present disclosure, the computing system 104 corresponds to the one or more electronic devices 102.

The computing system 104 includes one or more hardware processors. The computing system 104 further includes a memory coupled to the one or more hardware processors. The memory includes plurality of modules 106 in the form of programmable instructions executable by the one or more hardware processors. The plurality of modules 106 includes an image receiver module configured to receive one or more images, one or more videos or a combination thereof from a user via the one or more electronic devices associated with the user. The plurality of modules 106 further includes a visual signature generation module configured to generate one or more visual signatures based on the received one or more images or one or more videos using visual signature based convolutional neural network model. The generated one or more visual signatures are stored in the form of a queryable data structure in a storage database.

The plurality of modules 106 further includes a product determination module configured to determine the one or more products corresponding to the generated one or more visual signatures.

The plurality of modules 106 further includes a product parameter extraction module configured to obtain one or more product parameters from the determined one or more products. The one or more product parameters includes name of the one or more products, price details of the one or more products, offers presented for the one or more products, manufactured date and expiry date of the one or more products, coupons applicable for the one or more products.

The plurality of modules 106 further includes a record generation module configured to generate one or more electronic records based on the received one or more images and the one or more product parameters.

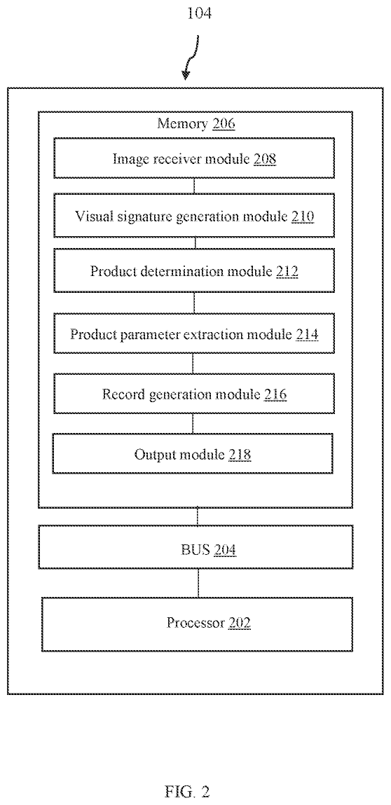

The plurality of modules 106 further includes an output module configured to output the generated one or more electronic records on a user interface of the one or more electronic devices associated with the user. Detailed explanation on the computing system 104 and the plurality of modules 106 is depicted in FIG. 2.

As used herein, “computing environment” refers to a processing environment comprising configurable computing physical and logical assets, for example, networks, servers, storage, applications, services, etc., The computing environment 100 provides on-demand network access to a shared pool of the configurable computing physical and logical assets. The server may include one or more servers on which the OS is installed. The servers may comprise one or more processors, one or more storage devices, such as, memory units, for storing data and machine-readable instructions for example, applications and application programming interfaces (APIs), and other peripherals.

Those of ordinary skilled in the art will appreciate that the hardware depicted in FIG. 1 may vary for particular implementations. For example, other peripheral devices such as an optical disk drive and the like, Local Area Network (LAN), Wide Area Network (WAN), Wireless (e.g., Wi-Fi) adapter, graphics adapter, disk controller, input/output (I/O) adapter also may be used in addition or in place of the hardware depicted. The depicted example is provided for the purpose of explanation only and is not meant to imply architectural limitations with respect to the present disclosure.

Those skilled in the art will recognize that, for simplicity and clarity, the full structure and operation of all data processing systems suitable for use with the present disclosure is not being depicted or described herein. Instead, only so much of the computing system 104 as is unique to the present disclosure or necessary for an understanding of the present disclosure is depicted and described. The remainder of the construction and operation of the computing system 104 may confirm to any of the various current implementation and practices known in the art.

FIG. 2 is a block diagram depicting a computing system 104, such as those shown in FIG. 1 capable of self-billing one or more products, in accordance with an embodiment of the present disclosure. A processor(s) 202 (also referred as one or more hardware processor), as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The processor(s) 202 may also include embedded controllers, such as generic or programmable logic devices or arrays, application specific integrated circuits, single-chip computers, and the like.

A memory 206 may be non-transitory volatile memory and non-volatile memory. The memory 206 may be coupled for communication with the processor(s) 202, such as being a computer-readable storage medium. The processor(s) 202 may execute machine-readable instructions and/or source code stored in the memory 206. A variety of machine-readable instructions may be stored in and accessed from the memory 206. The memory 206 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 206 includes a plurality of subsystems stored in the form of machine-readable instructions on any of the above-mentioned storage media and may be in communication with and executed by the processor(s) 202.

The plurality of modules 106 includes an image receiver module 208, a visual signature generation module 210, a product determination module 212, a product parameter extraction module 214, a record generation module 216 and an output module 218.

The image receiver module 208 is configured to receive one or more images, one or more videos or a combination thereof from a user via the one or more electronic devices 102 associated with the user. The image receiver module 208 further comprises the one or more images of the one or more products such as, for example, but not limited to, groceries, medicines, vegetables, and dairy products or the like. The one or more images corresponds to a format of a tensor of order three.

The visual signature generation module 210 is configured to generate one or more visual signatures based on the received one or more images, one or more videos or a combination thereof using visual signature based convolutional neural network model. The one or more visual signatures are unique visual representations of the one of one or more products. The generated one or more visual signatures are stored in the form of a queryable data structure in a storage database. In an embodiment of the present disclosure, the one or more visual signatures are stored in the storage database as blobs or objects. In an embodiment of the present disclosure, the image signatures are stored as a two order Tensor [sequence of one order tensor] and an array carrying information about the product whose visual signature is at corresponding address of the 2D order Tensor. The visual signature generation module 210 is further configured to update a prestored visual signature database by adding and deleting inventory items based on addition or deletion of the one or more products on an image registry which comprises a data associated with an inventory of a store. The visual signature generation module 210 is further configured to convert a tensor of order three format of the one or more images into a tensor of order one format using the visual signature based convolutional neural network model. In an embodiment of the present disclosure, the visual signature based convolutional neural network model converts the one or more images into a one order visual signature for product, known as image embedding. The one or more visual signatures corresponds to the form of tensor of order one format. For example, the visual signature of a beverage can in a tensor of order one is [0.048, 0.041, 0.008, 0.037, 0.074, 0.052, 0.018, 0.04, 0.103, 0.04, 0.121, 0.051, 0.127, 0.02, 0.11, 0.157, 0.133, 0.003, 0.003, 0.02, 0.01, 0.022, 0.091, 0.076, 0.161, 0.055, 0.135, 0.188, 0.04, 0.148, 0.082, 0.166, 0.059, 0.076, 0.097, 0.0, 0.173, 0.133, 0.0, 0.077, 0.135, 0.177, 0.09, 0.096, 0.06, 0.088, 0.147, 0.129, 0.015, 0.067, 0.053, 0.136, 0.011, 0.175, 0.003, 0.128, 0.087, 0.058, 0.039, 0.025, 0.035, 0.058, 0.033, 0.088, 0.167, 0.041, 0.07, 0.005, 0.016, 0.106, 0.081, 0.0, 0.029, 0.038, 0.068, 0.091, 0.0, 0.03, 0.062, 0.0, 0.047, 0.174, 0.074, 0.145, 0.003, 0.073, 0.231, 0.009, 0.088, 0.039, 0.115, 0.055, 0.134, 0.078, 0.052, 0.055, 0.09, 0.009, 0.016, 0.173, 0.05, 0.018, 0.083, 0.139, 0.055, 0.204, 0.023, 0.135, 0.074, 0.16, 1.17, 0.067]. For example, the tensor of order 3 is: [[[0,0,1],[1,0,1]],[[0.5,0.3,1.2],[0.7,0.8,0.33]]].

The product determination module 212 is configured to determine the one or more products corresponding to the generated one or more visual signatures. The product determination module 212 is further configured to obtain more than one of one or more visual signatures corresponding to the one or more products and prompting a notification for clarifying the one or more visual signatures to be paired with the one or more products on a user interface of the one or more electronic devices 102. The product determination module 212 is further configured to compare the one or more visual signatures with the prestored one or more visual signatures in a prestored visual signature database. The comparison is performed using a Euclidian distance, a Cosine distance or a combination thereof.

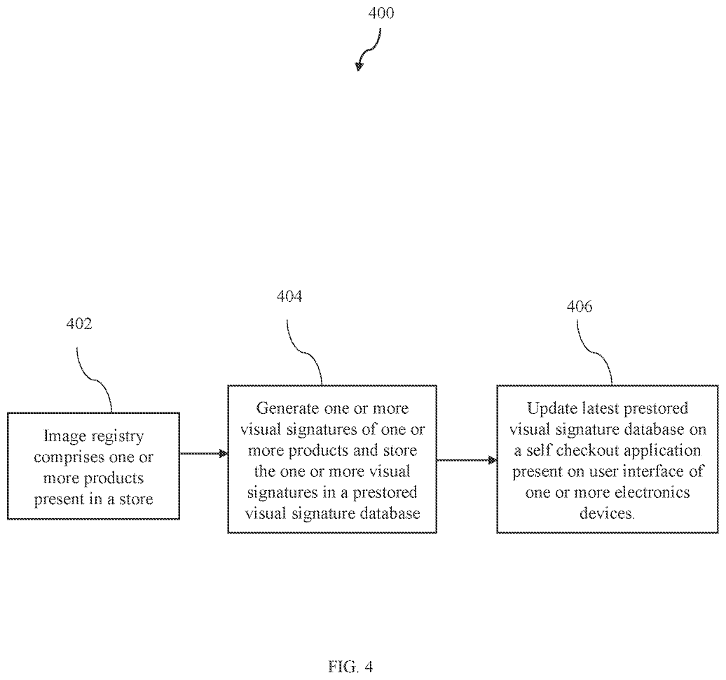

The product parameter extraction module 214 is configured to obtain one or more product parameters from the determined one or more products. The one or more product parameters comprises for example, but not limited to, name of the one or more products, price details of the one or more products, offers presented for the one or more products, manufactured date, and expiry date of the one or more products, coupons applicable for the one or more products or the like. In an embodiment of the present disclosure, the one or more product parameters are obtained by using steps 402-406, as shown in FIG. 4. In another embodiment of the present disclosure, the one or more product parameters are obtained by using Hypertext Transfer Protocol (HTTP) based on internet connection.

The record generation module 216 is configured to generate one or more electronic records based on the received one or more images and the one or more product parameters. The one or more electronic records includes a list of the one or more products purchased by the user and a total sum of amount to be paid for the one or more products. For example, the one or more products and their prices are listed on a document and the total sum is calculated by applying the offers.

The output module 218 is configured to output the generated one or more electronic records on the user interface of the one or more electronic devices 102 associated with the user.

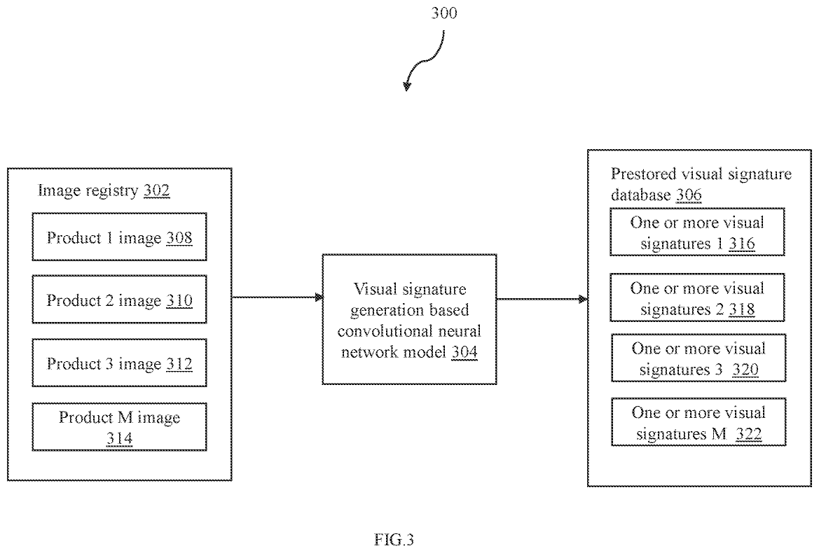

FIG. 3 is a block diagram 300 depicting a process of creation of one or more visual signatures, in accordance with an embodiment of the present disclosure. On a self-checkout application's service side, an image registry 302 comprises a data associated with an inventory of a store. Such image registry 302 includes product 1 to M images 308-314 (also referred as one or more images) of one or more products present in a store. This image registry 302 is passed through a neural network using a visual signature based convolutional neural network model 304 and one or more visual signatures 1 to M 316-322 are generated for every product 1 to M image 308-314 which may be stored in a prestored visual signature database 306. The product 1 image 308 is in a tensor of order 3 format. Using the visual signature based convolutional neural network model 304, the product 1 image 308 may be converted to a special vector (also referred as tensor of order one format) which is the one or more visual signatures 322. The visual signature based convolutional neural network model 304 is trained to differentiate from over ten thousand different products from one another by creating vectors for the product 1 image 308. A unique signature (also referred as one or more signatures) for every product (also referred as one or more products) is generated using the visual signature based convolutional neural network model 304.

FIG. 4 is a block diagram 400 depicting a process of updating latest prestored visual signature database 406, in accordance with an embodiment of the present disclosure. A store which is able to utilize a self-checkout application may have to maintain an image registry 402 which comprises a data associated with an inventory of a store which comprises one or more products present in the store. Here, it is inferred that the image registry 402 associated with a store is present. The image registry 402 comprises one or more products present in the store. The present invention generates one or more visual signatures 404 (also referred as prestored visual signature database) for the one or more products using a visual signature-based convolution neural network model 304. The one or more visual signatures 404 are stored in a prestored visual signature database. In an embodiment of the present disclosure, the visual signature-based convolution neural network model 304 run on the server side to generate the one or more visual signatures of the prestored visual signature database and on the one or more electronic devices 102 to generate the one or more visual signatures for the one or more images captured by the one or more electronic devices 102. In an embodiment of the present disclosure, when the self-checkout application is downloaded on the one or more electronic devices 102, the one or more visual signatures corresponding to the prestored visual signature database are synced on the one or more electronic devices 102. As and when the one or more products are added and removed, the latest prestored visual signature database 406 on the one or more electronic devices 102 is updated accordingly on a self-checkout application present on a user interface of one or more electronic devices 102 associated with a user.

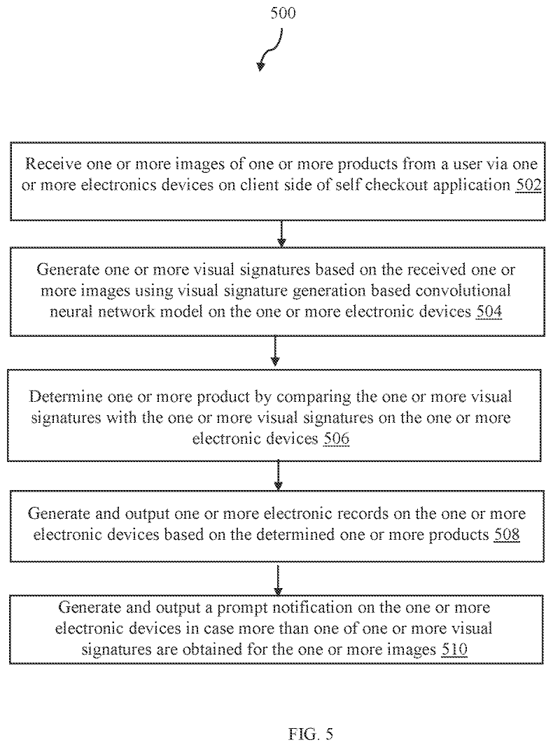

FIG. 5 is an exemplary process flowchart depicting a process of performing device operations 500 on a self-checkout application, in accordance with an embodiment of the present disclosure. While enabling the self-checkout application for a store, at step 502 one or more images of one or more products is received from the user via one or more electronic devices 102. The user downloads the self-checkout application on the one or more electronic devices 102 associated with the user and the user clicks the one or more images of the one or more products present on user's shopping cart. This part of the process happens on client side of the self-checkout application. In an embodiment of the present disclosure, when the self-checkout application is downloaded on the one or more electronic devices 102, the one or more visual signatures corresponding to the prestored visual signature database are synced on the one or more electronic devices 102.

At step 504, one or more visual signatures are generated based on the received one or more images using a visual signature-based convolution neural network model 304 on the one or more electronic devices 102. The one or more visual signatures of all the one or more images are arranged in a queryable data structure utilized at the time of checkout and stored on the one or more electronic devices 102.

Further, at step 506, the one or more products are determined by comparing the one or more visual signatures with prestored one or more visual signatures on the one or more electronic devices 102. In an embodiment of the present disclosure, the prestored one or more visual signatures present on a prestored signature database on the server side of the self-checkout application are synced on the one or more electronic devices 102. This aforementioned comparison is performed using Euclidean distance or Cosine Distance depending on an image registry 302 which comprises a data associated with an inventory of a store.

At step 508, one or more electronic records are generated and outputted on the self-checkout application downloaded on the one or more electronic devices 102 based on the determined one or more products. One or more product parameters are generated based on the determined one or more products through which the one or more electronic records are generated.

At step 508, a prompt notification is generated and outputted on the one or more electronic devices if more than one of one or more visual signatures are obtained for the one or more products to clarify which one or more products to match.

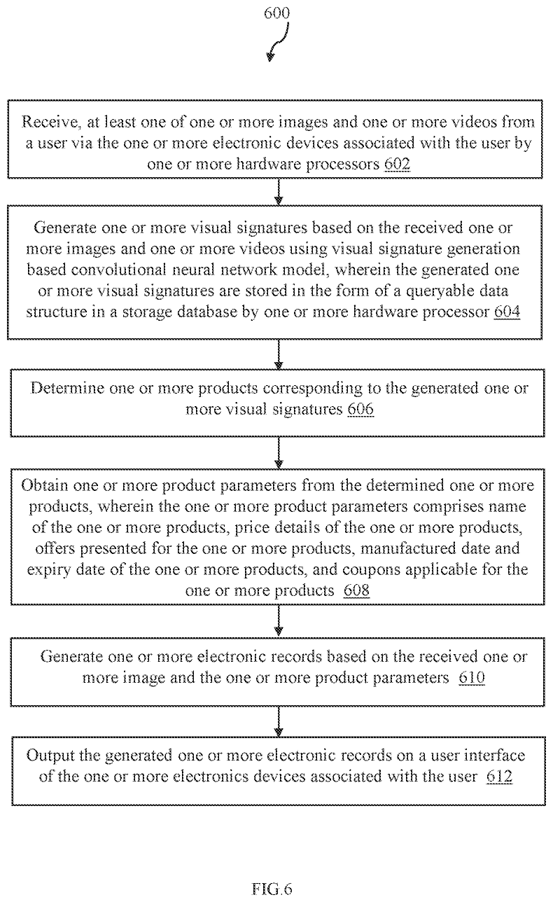

FIG. 6 is an exemplary process flowchart depicting a method 600 for self-billing one or more products, in accordance with an embodiment of the present disclosure. At step 602, one or more images, one or more videos or a combination thereof are received from a user via the one or more electronic devices 102 associated with the user by processor(s) 202.

At step 604, one or more visual signatures 316 are generated based on the received one or more images, one or more videos or a combination thereof using a visual signature based convolutional neural network model 304. The generated one or more visual signatures are stored in the form of a queryable data structure in a storage database.

At step 606, one or more products are determined corresponding to the generated one or more visual signatures.

At step 608, one or more product parameters are obtained from the determined one or more products. The one or more product parameters comprises name of the one or more products, price details of the one or more products, offers presented for the one or more products, manufactured date and expiry date of the one or more products, and coupons applicable for the one or more products.

At step 610, one or more electronic records are generated based on the received one or more image and the one or more product parameters. In an embodiment of the present disclosure, the one or more electronic records include a list of the one or more products purchased by the user and a total sum of amount to be paid for the one or more products.

At step 612, the generated one or more electronic records are outputted on a user interface of the one or more electronic devices 102 associated with the user.

The method 600 further comprises the one or more images of the one or more products such as for example by not limited to groceries, medicines, vegetables, and dairy products and the like.

The method 600 further comprises updating a prestored visual signature database 306 by adding and deleting inventory items based on addition or deletion of the one or more products on an image registry 302 which comprises a data associated with an inventory of a store.

The method 600 further comprises obtaining more than one of one or more visual signatures corresponding to the one or more products and prompting a notification for clarifying the one or more visual signatures to be paired with the on the user interface of the one or more electronic devices 102.

The method 600 further comprises comparing the one or more visual signatures with prestored one or more visual signatures in the prestored visual signature database 306. The comparison is performed using a Euclidian distance, a Cosine distance or a combination thereof.

The method 600 further comprises converting a tensor of order three format of the one or more images into a tensor of order one format using the visual signature based convolutional neural network model 304. In an embodiment of the present disclosure, the visual signature based convolutional neural network model 304 converts the one or more images into a one order visual signature for product, known as image embedding. The one or more visual signatures corresponds to the form of tensor of order one format.

In an embodiment, it is inferred that the self-checkout application's front end (also referred as client side) is utilized to perform self-checkout on the one or more electronic device 102 associated with the consumer (also referred as user). The one or more visual signatures 316 of the image registry 302 is generated on a server side of the self-checkout application and is transferred to the client side of the self-checkout application.

In an embodiment, the present invention has the following advantages. The present invention may be utilized to automate clerical tasks in supply chain. The present invention saves time as the consumer does not have to wait in long queue during checkout in the store. This results in enabling social distancing in the store which is useful during pandemic times.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various sub-systems described herein may be implemented in other sub-systems or combinations of other sub-systems. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to a bus 204 to gather user input. Additionally, a communication adapter connects the bus 204 to a data processing network, and a display adapter connects the bus 204 to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The specification has described a method and a system for. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

We claim:

1. A method for self-billing one or more products, the method comprising:
receiving, by one or more hardware processors, at least one of one or more images and one or more videos from a user via the one or more electronic devices associated with the user;
generating, by one or more hardware processors, one or more visual signatures based on the at least one of: received one or more images and one or more videos using a visual signature based convolutional neural network model, wherein the generated one or more visual signatures are stored in the form of a queryable data structure in a storage database;
determining, by one or more hardware processors, one or more products corresponding to the generated one or more visual signatures;
obtaining, by one or more hardware processors, one or more product parameters from the determined one or more products, wherein the one or more product parameters comprises name of the one or more products, price details of the one or more products, offers presented for the one or more products, manufactured date and expiry date of the one or more products, and coupons applicable for the one or more products;
generating, by one or more hardware processors, one or more electronic records based on the received one or more image and the one or more product parameters, wherein the one or more electronic records comprise: a list of the one or more products purchased by the user and a total sum of amount to be paid for the one or more products; and
outputting, by one or more hardware processors, the generated one or more electronic records on a user interface of the one or more electronic devices associated with the user.

2. The method as claimed in claim 1, wherein receiving the one of or more images or one or more videos from the user further comprises:
the one or more images of the one or more products comprising groceries, medicines, vegetables and dairy products.

3. The method as claimed in claim 1, wherein generating the one or more visual signatures based on the received one or more images or one or more videos further comprises:
updating a prestored visual signature database by adding and deleting inventory items based on addition or deletion of the one or more products on an image registry comprising a data associated with an inventory of a store.

4. The method as claimed in claim 1, wherein determining, the one or more products corresponding to the generated one or more visual signatures further comprises:
obtaining more than one of one or more visual signatures corresponding to the one or more products; and
prompting a notification for clarifying the one or more visual signatures to be paired with the one or more products on the user interface of the one or more electronic devices.

5. The method as claimed in claim 1, wherein determining one or more products corresponding to the generated one or more visual signatures further comprises:
comparing the one or more visual signatures with prestored one or more visual signatures in the prestored visual signature database, wherein the comparison is performed using at least one of: Euclidian distance and a Cosine distance.

6. The method as claimed in claim 1, wherein generating the one or more visual signatures based on the received one or more images or one or more videos further comprises:
converting a tensor of order three format of the one or more images into a tensor of order one format using the visual signature based convolutional neural network model, wherein the one or more visual signatures corresponds to the form of tensor of order one format.

7. A computing system capable of self-billing the one or more products, the computing system comprising:
one or more hardware processors; and
a memory coupled to the one or more hardware processors, wherein the memory comprises plurality of modules in the form of programmable instructions executable by the one or more hardware processors, wherein the plurality of modules comprises:
an image receiver module configured to receive at least one of one or more images and one or more videos from the user via the one or more electronic devices associated with the user;
a visual signature generation module configured to generate the one or more visual signatures based on the received at least one of: one or more images and one or more videos using the visual signature based convolutional neural network model, wherein the generated one or more visual signatures are stored in the form of a queryable data structure in the storage database;
a product determination module configured to determine one or more products corresponding to the generated one or more visual signatures;
a product parameter extraction module configured to obtain one or more product parameters from the determined one or more products, wherein the one or more product parameters comprises name of the one or more products, price details of the one or more products, offers presented for the one or more products, manufactured date and expiry date of the one or more products, coupons applicable for the one or more products;
a record generation module configured to generate one or more electronic records based on the received one or more images and the one or more product parameters, wherein the one or more electronic records comprise: a list of the one or more products purchased by the user and a total sum of amount to be paid for the one or more products; and
an output module configured to output the generated one or more electronic records on the user interface of the one or more electronic devices associated with the user.

8. The computing system as claimed in claim 7, wherein, the image receiver module further comprising the one or more images of the one or more products comprising groceries, medicines, vegetables, and dairy products.

9. The computing system as claimed in claim 7, wherein the visual signature generation module is further configured to update the prestored visual signature database by adding and deleting inventory items based on addition or deletion of the one or more products on the image registry comprising a data associated with an inventory of a store.

10. The computing system as claimed in claim 7, wherein, the product determination module is further configured to obtain more than one of one or more visual signatures corresponding to the one or more products; and
prompt a notification for clarifying the one or more visual signatures to be paired with the one or more products on the user interface of the one or more electronic devices.

11. The computing system as claimed in claim 7, wherein, the product determination module is further configured to compare the one or more visual signatures with the prestored one or more visual signatures in the prestored visual signature database, wherein the comparison is performed using at least one of: the Euclidian distance and the Cosine distance.

12. The computing system as claimed in claim 7, wherein, the visual signature generation module is further configured to convert a tensor of order three format of the one or more images into a tensor of order one format using the visual signature based convolutional neural network model, wherein the one or more visual signatures corresponds to the form of tensor of order one format.
